(19) United States
(12) Patent Application Publication
(10) Pub. No.: US 2006/0089173 A1
(43) Pub. Date: Apr. 27, 2006

(54) Apparatus and method for utilizing trunk in mobile communications system

(75) Inventor: Chang-Bum Chun, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/248,261

(22) Filed: Oct. 13, 2005

(30) Foreign Application Priority Data
Oct. 25, 2004 (KR) 85492/2004

(51) Int. Cl. H04B 1/38

(52) U.S. Cl. 455/561

(57) ABSTRACT

An apparatus and method for utilizing a trunk in a mobile communications system capable of efficiently utilizing and operating the trunk when accepting subscribers for various services in one base station, wherein the one base station can accept subscribers for mobile communications services in any mobile communications system using different frequency bands, respectively, a traffic can be simply divided only by performing a base-pass filtering, the changed amount of the traffic can be monitored and measured in a real-time manner, so that interface links such as lub or Abis do not have to be connected individually to be appropriate for each type of mobile communications services, but rather the minimum number of links are connected so as to efficiently operate the links.

### CROSS REFERENCE TO RELATED ART

Pursuant to 35 U.S.C 119(a), this application claims the benefit of Korean Patent Application No. 2004-85492, filed on Oct. 25, 2004, which is hereby incorporated by reference in its entirety.

### BACKGROUND OF THE INVENTION

1. Field of the Invention

The present invention relates to a mobile communications system, and particularly, to an apparatus and method for utilizing a trunk in a mobile communications system.

2. Description of the Background Art

In base stations of most mobile communications systems, divided technologies for modules within the base stations and connection standardization were not established. Accordingly, each company developed a base station system according to a different specification within the system. As a result, the same functions were disadvantageously developed by different companies, and such systems were not compatible to each other and thus could only be used for a particular purpose.

Thus, in order to prevent duplicated investments for the same research and development performed by different manufacturers, modularization of the base station system and standardization of interfaces between each module were considered. That is, with the expectation to reduce the costs of the system, reduce the time for product development, and to select various competitive products with respect to each used module by properly defining the standardization of the internal modules of the base station, a method directed to an open structure with respect to software and hardware of the base station was discussed.

In general, Open Base Station Architecture Initiative (OBSAI) is a meeting that the base station operators, manufacturers for modules and components, and the like established in September 2002 for standardization of the base station technologies under the lead of major base station providers. In a forum comprising about 110 communications companies joined in the meeting, an internal interface specification and a module specification for the base station structure were defined. Portions of the specifications has already been completed by the base station standardization activities in the OBSAI.

FIG. 1 is a structural diagram illustrating a typical OBSAI standardized structure.

Referring to FIG. 1, the OBSAI standardized structure is constructed with four functional parts such as a radio module, a processing module, a transport module, and a control module. Accordingly, each manufacturer can fabricate the base station appropriately considering different requirements of users according to the access techniques, configurations, stability, and capacity.

The radio module manages functions, such as Radio Frequency (RF) transmission and reception between a digital base band signal and an analog RF signal, RF amplification, and RF modulation.

The processing module manages a base band processing for radio (air) interfaces and a function of a channel modem.

The transport module connects an outer network interface of the base station and an inner network interface of a standardized the transmitting/receiving station so as to exchange information with each other.

The control module controls the exchanging of signals between modules and providing connections between the modules. Also, the control module manages the functions of operation and maintenance of the base station, such as providing a basic control processing function for the transmitting/receiving station, monitoring activities of every transmitting/receiving stations, and reporting the state and outcome to a base station manager.

Reference points 1 to 3 (RP1, RP2, RP3) are open interfaces. The RP1 allows the exchanging of signals such as control signals, execute signals, status signals, alarming signals, and the like, and allows the exchanging of data between the control module and a clock block and other base station blocks. The RP2 allows the exchanging of user data between the transport module and a base band block. The RP3 allows the exchanging of the user data of a radio interface and high-speed control data between the base band block and the RF block.

One of the main purposes of the OBSAI is to receive various radio interfaces between the base station and a Mobile Station (MS) related to one base station, and allows the one base station to be connected to a Base Station Controller (BSC) or a Radio Network Controller (RNC) of various services.

However, if subscribers having subscribed to various services are simultaneously intended to access one base station, as in the conventional mobile communications system, a trunk such as the E1 link or the T1 link connected to the BSC or the RNC must be redundantly installed. If the links are installed one by one, a large number of links are required, which causes consumption of cost therefor.

In particular, in a mobile communications network, an increase of the number of base station requires a considerable number of trunks which must be connected to each base station.

### BRIEF DESCRIPTION OF THE INVENTION

Therefore, an object of the present invention is to provide an apparatus and method for utilizing a trunk in a mobile communications system capable of efficiently utilizing and operating a trunk when accepting subscribers having subscribed in various services in one base station.

To achieve these and other advantages and in accordance with the purpose of the present invention, as embodied and broadly described herein, there is provided an apparatus for utilizing a trunk in a mobile communications system comprising: a base station to receive signals from a Mobile Station (MS or UE) and perform a Radio Frequency (RF) processing and a base band processing; a band-pass filter to perform a band-pass filtering by receiving the signals inputted from the base station; a traffic measuring unit to measure a changed amount of a traffic by receiving an output of the band-pass filter; and a link controller to allocate and connect links as many as required for a connection to each interface according to data measured by the traffic measuring unit.

Preferably, the base station, which is an OBSAI base station, may be connected to a User Equipment (UE) of 3GPP (Third Generation Partnership Project) system such as GSM (Global System for Mobile communications) or WCDMA (Wideband Code Division Multiple Access) and also be connected to the MS of a 3GPP2 system such as CDMA, via Uu or Um which are outer interface of the base station.

Preferably, the base station includes: a controller to manage and control overall operations and resources of the base station through a Reference Point (RP) 1 among open interfaces; a remote Radio Frequency (RF) processor to receive the signals from a mobile station (i.e., a user equipment) under the control of the controller; an RF processor to process the RF signal received from the remote RF processor at an RP3 under the control of the controller; a base band processor to perform a base band processing at an RP2 under the control of the controller; a transmitter to transmit the traffic processed in the base band processor to the link controller through a trunk; and a power unit to support power to the base station.

The base station may further include various types of network interfaces or a proprietary module such as a Global Positioning System (GPS) timing receiver.

Preferably, the traffic measuring unit monitors and measures the changed amount of the traffic according to services in each mobile communications system in a real-time manner to thusly allow the changed amount to be used to allocate links in the link controller.

Preferably, the link controller divides data on the basis of a Virtual Path (VP) value and a Virtual Channel (VC) value with reference to the data measured by the traffic measuring unit so as to connect the links.

To achieve these and other advantages and in accordance with the purpose of the present invention, there is provided a method for utilized a trunk in a mobile communications system comprising: receiving signals from a mobile station (i.e., user equipment); performing a band-pass filtering for the received signals; measuring a traffic amount of a signal filtered by the band-pass filtering process; and allocating and connecting links according to the measured data.

Preferably, the mobile station, which is a mobile station subscribed in various types of mobile communications systems including 3GPP system and 3GPP2 system, and the base station receives signals from the mobile station via an outer interface such as Uu or Um.

Preferably, in the step of measuring the traffic amount, changes of the traffic amount according to services of each mobile communications system, the traffic flowing in from the band-pass filter, are monitored in a real-time manner, and the changed traffic amount is measured.

Preferably, during link connecting, data is divided and links are connected on the basis of the Virtual Path (VP) value and the Virtual Channel (VC) value with reference to the measured data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a structural view illustrating a typical OBSAI specification structure;

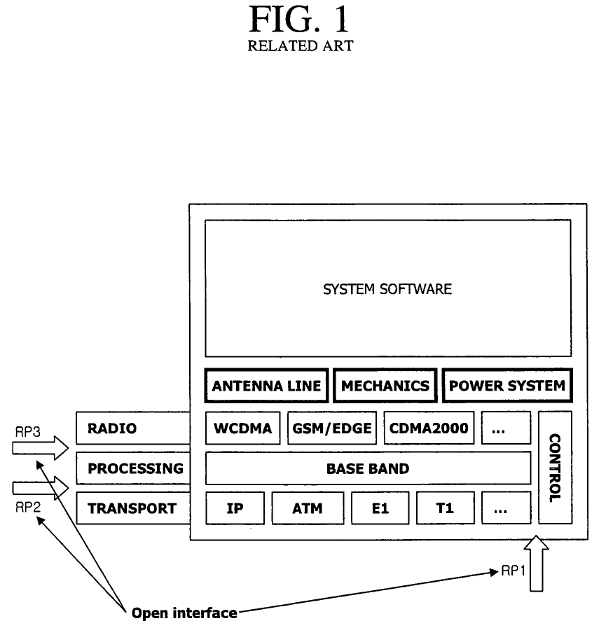

FIG. 2 illustrates an exemplary construction of an apparatus for utilizing a trunk of a mobile communications system according to an exemplary embodiment of the present invention; and

FIG. 3 is a flowchart illustrating sequential steps of a method for utilizing a trunk of a mobile communications system according to an exemplary embodiment of the present invention.

### DETAILED DESCRIPTION OF THE INVENTION

Reference will now be made in detail to the preferred embodiments of the present invention, examples of which are illustrated in the accompanying drawings.

Explaining the present invention, if the related reference or a detailed description for a construction is recognized to make the description of the present invention obscure, it may be omitted.

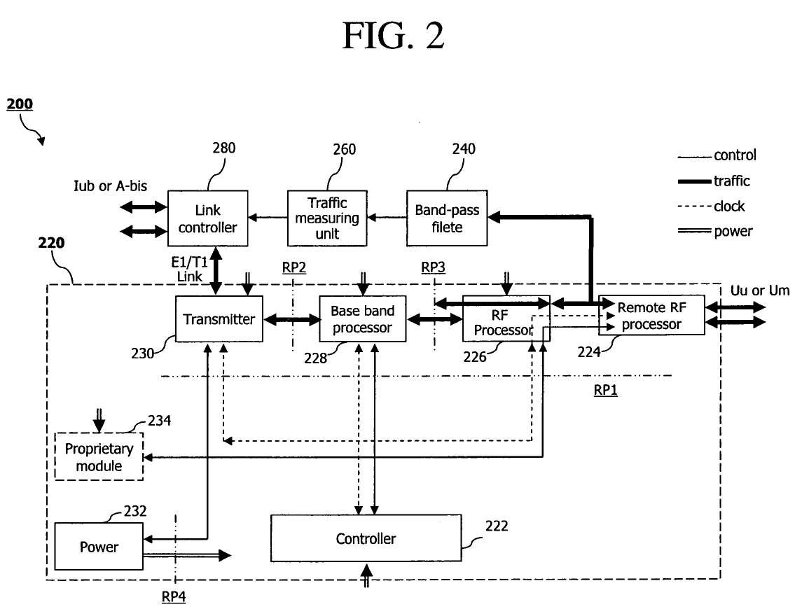

FIG. 2 illustrates an exemplary construction of an apparatus for utilizing a trunk of a mobile communications system according to an embodiment of the present invention.

As illustrated in FIG. 2, the apparatus 200 for utilizing a trunk comprises: a base station 220 to receive signals from a Mobile Station (MS or UE) and perform a Radio Frequency (RF) processing and a base band processing; a band-pass filter 240 to perform a band-pass filtering by receiving the signals inputted from the base station 220; a traffic measuring unit 260 to measure a changed amount of traffic by receiving an output of the band-pass filter 240; and a link controller 280 to allocate and connect links as many as required for a connection to each interface according to data measured by the traffic measuring unit 260.

The base station 220, which is an OBSAI base station, may be connected to a mobile station (i.e., User Equipment (UE)) of 3GPP system such as GSM or WCDMA or be connected to a Mobile Station (MS) of 3GPP2 system such as CDMA, via Uu or Um which are outer interfaces of the base station. That is, the base station 220 may communicate with any type of mobile communications systems using different frequency bands, such as cellular using 800 MHz frequency band, GSM using 900 MHz, GSM used in the Europe and using 1800 MHz, CDMA system widely used in Korea, US PCS using 1900 MHz, WCDMA using 2100 MHz, and the like.

The base station 220 includes: a controller 222 to manage and control overall operations and resources of the base station through a Reference Point (RP) 1 among open interfaces; a remote Radio Frequency (RF) processor 224 to receive signals from a mobile station (i.e., a user equipment) under the control of the controller 222; an RF processor 226 to process the RF signals received from the remote RF processor 224 at an RP3 under the control of the controller 222; a base band processor 228 to perform a base band processing at an RP2 under the control of the controller 222; a transmitter 230 to transmit the traffic processed in the base band processor 228 to the link controller 280 through a trunk such as E1 link or T1 link; and a power unit 232 to support power to the base station 220.

Also, the base station may selectively include various types of network interfaces or a proprietary module 234 such as a GPS timing receiver so as to support specific functions which are not obvious whether to be supported by the controller 222, the remote RF processor 224, the RF processor 226, the base band processor 228, the transmitter 230, and the like.

The band-pass filter 240 performs band-pass filtering with respect to the signals received from the mobile station of various mobile communications systems, so as to simply divide the signals according to each frequency band.

The traffic measuring unit 260 monitors the changed amount of the traffic according to services in each mobile communications system to measure the traffic amount. The changed traffic amount is thus used to allocate links in the link controller 280.

The link controller 280 divides data on the basis of a Virtual Path (VP) value and a Virtual Channel (VC) value with reference to the data measured by the traffic measuring unit 260, and thus connects links.

The link controller 280 may be also connected to a Radio Network Controller (RNC) of the 3GPP system or a Base Station Controller (BSC) of the 3GPP2 system via lub or Abis which are outer interfaces of the base station during link connecting.

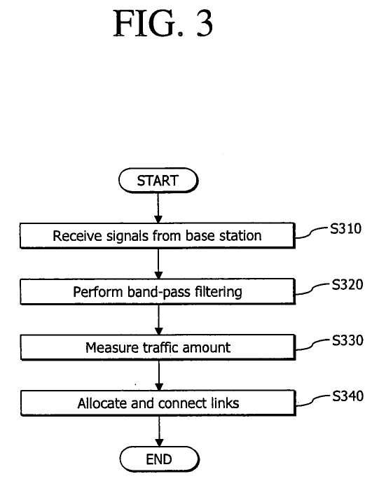

FIG. 3 is a flowchart illustrating sequential steps of a method for utilizing a trunk in a mobile communications system according to an embodiment of the present invention.

Referring to FIG. 3, the base station 220 receives signals from the mobile station (MS or UE) having subscribed to various mobile communications system including the 3GPP system and the 3GPP2 system via an outer interface such as Uu or Um, and then transmits the received signals to the band-pass filter 240 (S310).

The band-pass filter having received the signals from the base station 220 performs the band-pass filtering for the signals to thusly divide the signals of various services according to each frequency band, and then transmits the filtered signal to the traffic measuring unit 260 (S320). The traffic measuring unit 260 then monitors the changing of the traffic amount according to services of each mobile communications system, the traffic flowing in from the band-pass filter 240, and measures the changed traffic amount (S330).

When the traffic amount is completely measured, the link controller 280 allocates and connects links as many as required for a connection to each outer interface (lub or Abis) with reference to the data measured in the traffic measuring unit 260 (S340).

For example, it is assumed that the traffic amount of a subscriber using each service is set by the following rate, and procedures therefor will be explained as follows.

If it is confirmed that the traffic amounts according to each band filtered by the band-pass filter 240 are measured by the traffic measuring unit 260 with a rate of Cellular:GSM:US PCS:WCDMA=2:3:6:9, the link controller 280 allocates E1 link or T1 link to be appropriate for the rate.

At this time, data for each service can be simultaneously sent via E1 link or T1 link, and also the data for each service can be divided for sending on the basis of the VP/VC values after extending the E1 link or the T1 link up to a junction of the controller (BSC or RNC) in maximum.

Thus, in the present invention, the trunk such as the E1 and T1 links can be efficiently are assigned to the outer interfaces such lub or Abis connected to the controller such as the BSC or the RNC proposed in the OBSAI, and various interfacing is performed, thereby efficiently utilizing the trunk.

As mentioned above, in the apparatus and method for utilizing the trunk in the mobile communications system according to the present invention, one base station can accept (receive) mobile communications service subscribers of any mobile communications system using different frequency bands, respectively, such as cellular using 800 MHz frequency band, GSM using 900 MHz, GSM used in the Europe and using 1800 MHz, CDMA system widely used in Korea, US PCS using 1900 MHz, WCDMA using 2100 MHz, and the like. Also, the lub or Abis interface link does not have to be individually connected to be appropriate for each type of mobile communications services, and the E1/T1 links which are not frequently used due to its small traffic amount can be utilized more efficiently.

Also, in the present invention, the band-pass filter is used so as to easily divide the traffic flowing in, and the traffic amount can be previously measured so as to prevent an overload effect which the traffic is concentrated into a specific service link, thereby efficiently operating the link.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for utilizing a trunk in a mobile communications system comprising:
a base station to receive signals from a Mobile Station (MS or UE) and perform a Radio Frequency (RF) processing and a base band processing;
a band-pass filter to perform a band-pass filtering by receiving the signals inputted from the base station;
a traffic measuring unit to measure a changed amount of the traffic by receiving an output of the band-pass filter; and
a link controller to allocate and connect links as many as required for a connection to each interface according to data measured by the traffic measuring unit.

2. The apparatus of claim 1, wherein the base station is an Open Base Station Architecture Initiative (OBSAI) capable of being connected to a mobile station (i.e., User Equipment (UE)) of 3GPP (Third Generation Partnership Project) system and a mobile station (MS) of 3GPP2 system via an outer interface of the base station.

3. The apparatus of claim 1, wherein the base station comprises:
a controller to manage and control overall operations and resources of the base station through a Reference Point (RP) 1 among open interfaces;
a remote Radio Frequency (RF) processor to receive signals from a mobile station (i.e., a user equipment) under the control of the controller;
an RF processor to process the RF signals received from the remote RF processor at an RP3 under the control of the controller;
a base band processor to perform the base band processing at an RP2 under the control of the controller;
a transmitter to transmit the traffic processed in the base band processor to the link controller through a trunk; and
a power unit to support power to the base station.

4. The apparatus of claim 3, wherein the base station further includes one or more proprietary modules.

5. The apparatus of claim 1, wherein the traffic measuring unit monitors and measures the changed amount of the traffic according to services of each mobile communications system in a real-time manner, to thusly use the changed traffic amount for allocating links in the link controller.

6. The apparatus of claim 1, wherein the link controller allocates the links as many as required for the connection of each outer interface with reference to data measured by the traffic measuring unit, and connects the links.

7. The apparatus of claim 6, wherein the outer interface is lub connected to a Radio Network Controller (RNC).

8. The apparatus of claim 6, wherein the outer interface is Abis connected to a Base Station Controller (BSC).

9. The apparatus of claim 6, wherein the minimum number of links are connected up to a controller junction.

10. The apparatus of claim 9, wherein data of the links is divided at the controller junction on the basis of a virtual path and a virtual channel.

11. The apparatus of claim 1, wherein the link is a E1 link or a T1 link.

12. A method for utilizing a trunk in a mobile communications system comprising:
receiving signals from a mobile station (i.e., user equipment);
performing a band-pass filtering for the received signals;
measuring a traffic amount of a signal filtered by the band-pass filtering process; and
connecting links according to the measured data.

13. The method of claim 12, wherein the mobile communications system includes 3GPP (Third Generation Partnership Project) system and 3GPP2 system.

14. The method of claim 12, wherein in the step of measuring the traffic amount, the changed amount of the traffic according to services in each mobile communications system is monitored in a real-time manner to measure the changed traffic amount.

15. The method of claim 12, wherein the links are allocated as many as required for the connection of each outer interface with reference to the measured data and the links are connected during link connecting.

16. The method of claim 15, wherein the outer interface is lub connected to a Radio Network Controller.

17. The method of claim 15, wherein the outer interface is Abis connected to a Base Station Controller.

18. The method of claim 15, wherein the minimum number of links are connected up to a controller junction.

19. The method of claim 18, wherein data of the links is divided at the controller junction on the basis of a virtual path and a virtual channel.

20. The method of claim 12, wherein the link is a E1 link or a T1 link.

21. The method of claim 12, wherein the mobile communications system includes GSM (Global System of Mobile communications), WCDMA (Wideband Code Division Multiple Access), and CDMA (Code Division Multiple Access) systems.
